(19) United States
(12) Patent Application Publication
(10) Pub. No.: US 2009/0134747 A1
(43) Pub. Date: May 28, 2009

(54) Piezoelectric Generator

(76) Inventors: Klaus Reichmann, Graz (AT); Igor Kartashev, Deutschlandsberg (AT); Wolfgang Athenstaedt, Graz (AT)

Correspondence Address: SLATER & MATSIL, L.L.P., 17950 PRESTON RD, SUITE 1000, DALLAS, TX, 75252-5793, US

(21) Appl. No.: 12/325,886

(22) Filed: Dec. 1, 2008

Related U.S. Application Data
(63) Continuation of application No. PCT/DE2007/000974, filed on May 31, 2007.

(30) Foreign Application Priority Data
Jun. 2, 2006 (DE) 10 2006 025 963.7

(51) Int. Cl. H02N 2/18

(52) U.S. Cl. 310/339

(57) ABSTRACT

A piezoelectric generator with a piezoelectric element and a mechanical transducer is specified and includes an oscillation device and an activator for transmitting a mechanical force to this device. The oscillation device is provided for generating a compressive stress on piezoelectric element.

This application is a continuation of co-pending International Application No. PCT/DE2007/000974, filed May 31, 2007, which designated the United States and was not published in English, and which claims priority to German Application No. 10 2006 025 963.7 filed Jun. 2, 2006, both of which applications are incorporated herein by reference.

### BACKGROUND

A piezoelectric generator is known, for instance, from the U.S. Pat. No. 5,751,091. This generator is used in a clock. Another piezoelectric generator is known, for instance, from the publication JP 11-146663 A.

### SUMMARY OF THE INVENTION

In one aspect, the invention specifies a highly efficient piezoelectric generator that is characterized by high mechanical stability.

For example, a piezoelectric generator is specified, with a piezoelectric element and an oscillation device having elements capable of oscillating, between which the piezoelectric element is clamped. The oscillation elements can oscillate one in opposition to the other.

The piezoelectric generator is suitable for transformation of mechanical energy into electrical energy. The piezoelectric generator can be realized for supplying power in portable electronic devices. The mechanical energy can be produced by body or air movements.

The oscillation device is preferably provided for prestressing the piezoelectric element. With a prestressed piezoelectric element it is possible to achieve a particularly high power density of the generator. The oscillation device is preferably provided for generating a compressive stress. The piezoelectric element can be pressed together along a longitudinal direction by the compressive stress. A shearing deformation of the piezoelectric element can also be produced by means of the compressive force.

The deformation of the piezoelectric element clamped in the oscillation device is caused by the oscillation of the oscillation elements. The mechanical energy of the oscillation device is transformed by means of the piezoelectric element into electrical energy.

An activator can be provided for transferring a mechanical force to the oscillation device. The activator is a force transmission element for exciting oscillations of the oscillation device. In a preferred variant, this excitation is characterized by an excitation frequency.

The oscillation device and the activator are components of a mechanical transducer in which there is a conversion between various forms of, or a transmission of, the mechanical energy.

The oscillation device and the piezoelectric element together form a resonant system, which is characterized by a natural frequency. This can be a fundamental frequency or a higher harmonic oscillation of the fundamental frequency. It is advantageous to select the excitation frequency to be equal to the natural frequency of this resonant system.

The oscillation device can be excited into mechanical oscillations at an oscillation frequency that determines the frequency of the electrical signal. In contrast to a microphone, which has a relatively large bandwidth, the oscillation device is preferably excited at a frequency that is approximately equal to the resonance frequency of the resonant system, or at a different, but constant, excitation frequency.

After an excitation phase in which the oscillation elements are deflected out of their rest position, the oscillation elements can oscillate freely. In a preferred variant, the oscillation device has energy storage elements mechanically coupled to the oscillation elements. The energy stored in the energy storage elements is converted after the provided maximum deflection into free oscillations of the oscillation device.

Independently of that, the mechanical transducer can comprise a second energy reservoir provided for exciting the oscillation elements and that is mechanically decoupled from the oscillation elements. This energy can be supplied to the oscillation elements directly or with the aid of the activator. The energy stored in this reservoir can be converted into free oscillations of the oscillation device or, if the activator is used, into forced oscillations.

The second energy reservoir can be constructed such that it is suitable for storing mechanical energy, in particular, the energy of uncorrelated mechanical effects. Possible mechanical effects are generally uncorrelated vibrations of the carrier on which the oscillation device is mounted. The energy from air pressure (e.g., by breathing and acoustic signals from the environment) can be accumulated in the energy reservoir. The activator withdraws energy from the reservoir and transmits it to the oscillation device. The energy of the energy reservoir can be used, for instance, for driving a transport device, explained below, to which the activator is coupled. The force transmission element (activator) and the oscillation device can be synchronized with respect to the natural frequency of the resonant system.

In one variant, the oscillation frequency of the oscillation device can coincide with the frequency of the excitation, which is preferably the natural frequency of the oscillation device. One excitation cycle can contain, for instance, one to three or even more oscillation cycles of the oscillation device. Excitation at an excitation frequency that is different from the natural frequency of the oscillation device is also possible.

The oscillation elements preferably each have one fixed end and one end that can oscillate freely. Each oscillation element can be a strip-shaped cantilever spring. The oscillation elements can form, for instance, the legs of an U-piece that is mounted in a fixation area (retention point) on a carrier. The fixation area is arranged in the area of the connecting part of the U-piece that has the lowest oscillation amplitude when the tuning fork oscillates.

In a preferred variant, the oscillation device has the shape of a tuning fork having alongside the U-piece a mounting projection that can be mounted on a carrier. The mounting projection is coupled to an area of the connecting part of the U-piece that has the lowest oscillation amplitude when the tuning fork oscillates.

The oscillation elements, however, can also be elongated strips that are fixed at both ends on the carrier. The center of these elements oscillates with maximum amplitude, like the free end of an oscillation element that is fixed at only one end.

The shocks (vibrations) of the carrier can cause the oscillation device to oscillate. The oscillation device can also be caused to oscillate by a gas pressure (e.g., air pressure), however. In both cases this can happen with or without an activator.

The activator represents, for example, a movable part that is suited to change the distance between the oscillation elements when it moves. Under the action of an external mechanical force, the activator contacts the oscillation elements in the area of their free ends, these oscillation elements being pressed apart. In a preferred variant, the activator carries out substantially periodic movements, so that the oscillation device is periodically excited. The motion of the activator can be a translation or a rotation. With each passage of the activator between the oscillation elements, the energy that is transferred to the piezoelectric element after passage of the activator is transferred to the energy storage elements.

The activator is preferably wedge-shaped, i.e., it has a tapering cross section. In one advantageous variant, the activator and/or the oscillation elements can at least in the contact area have a wear-resistant layer, i.e., a layer of a material that is resistant to wear with respect to the base material of the respective element. This layer can contain, for instance, Ir, W, Ti or any desired materials that minimize the friction losses at the contact surfaces between activator and oscillation element.

The mechanical transducer can comprise a transport device that is provided for transporting the activator. The transport device is positioned with respect to the oscillation device such that the activator can pass between the oscillation elements, preferably through the center of the area provided as a contact area.

The transport device in one variant can comprise a transport belt that is set in motion by means of transport rollers. The transport rollers are preferably coupled to an energy reservoir mentioned above. The transport device can alternatively comprise a rotary device in the form of a disk, a wheel or a ring that is rotatable about an axis of rotation and on which the activator is mounted that causes the oscillation elements to be pushed apart when the wheel rotates. The axis of rotation is preferably oriented transversely to the longitudinal direction of the oscillation elements.

The piezoelectric element has electrodes and at least one piezoelectric layer that is arranged between the electrodes. The electrodes can be external electrodes, for instance, which are arranged on the surface of a base body of the piezoelectric element. A piezoelectric layer is arranged between the external electrodes. An electric charge on the electrodes arises when this piezoelectric layer is deformed.

The electrodes can also be internal electrodes, however, each arranged between two piezoelectric layers. Preferably, several internal electrodes, connected alternately to a first and a second external electrode, are present. In this case the piezoelectric element represents a multilayer component.

Piezoelectric materials with high values for the piezoelectric modulus, e.g., the piezoelectric modulus d₃₁, d₃₃, d₁₅, are particularly suitable for piezoelectric layers. A particularly high efficiency can be achieved with these. A ceramic with piezoelectric properties is very suitable as a piezoelectric material.

The polarization direction of the piezoelectric layer is typically oriented transverse to the principal surfaces of the oscillation elements. In one variant, the polarization direction of the piezoelectric layer is oriented transverse to the internal electrodes or the external electrodes. The electrodes, particularly the external electrodes of the piezoelectric layer, can also be oriented substantially parallel to the polarization direction of the at least one piezoelectric layer.

The oscillation elements can preferably each have an energy storage element in the area of the ends that are capable of oscillating freely. Weights are suitable as energy storage elements. The weights are suitable not only for energy storage, but also for adjusting the oscillation frequency, in particular, the natural frequency of the oscillation device. With sufficiently large weights, for example, the length of the legs of the oscillation device can be chosen to be particularly small, which is in keeping with miniaturization of the piezoelectric generator.

The sides of the weights facing one another are preferably slanted such that the spacing between the weights decreases with the distance from the starting position of the activator. In the resting state, the minimum spacing between the weights is smaller than the widest point of the preferably wedge-shaped activator. The weights are contacted by the activator under the influence of the external mechanical force and deflected from their rest position, the weights storing the energy corresponding to their deflection.

For a respective oscillation element, a limiting element is preferably provided to limit the oscillation amplitude of this oscillation element.

### BRIEF DESCRIPTION OF THE DRAWINGS

The piezoelectric generator will now be explained with reference to schematic figures not drawn to scale. These show schematically:

FIG. 1, shows a structure of a piezoelectric generator in principle;

FIG. 2, shows the piezoelectric generator in cross section with an oscillation device and prestressed piezoelectric element, wherein oscillation elements of the oscillation device are pressed apart by an activator (above) and freely oscillate (below);

FIG. 2A, shows the structure of the piezoelectric element shown in FIGS. 2 and 5;

FIG. 3, shows a piezoelectric element in longitudinal section with piezoelectric layers whose polarization direction is oriented perpendicular to the internal electrodes of the piezoelectric element;

FIG. 4, shows a piezoelectric element in cross section with piezoelectric layers whose polarization direction is oriented parallel to the electrodes of the piezoelectric element;

FIG. 5, shows a piezoelectric element in cross section, in which stops for limiting the oscillation amplitude of the oscillation elements are provided in the mechanical transducer;

FIG. 5A, shows a variant of the piezoelectric generator shown in FIG. 5 in which the connecting part of the oscillation device subdivides the respective oscillation element into two oscillation arms;

FIG. 6, shows an oscillation device in cross section in which the activator moves transverse to the longitudinal direction of the oscillation elements;

FIG. 7, shows a transport device with a moving belt for displacing the activator along a line;

FIGS. 8A, 8B, show a perspective view and a plan view onto a variant of the transport device according to FIG. 7 in which the activator is arranged at the side of the moving belt;

FIG. 9, shows the plan view onto an additional variant of the transport device according to FIG. 7 in which the activator is arranged in the center area of the moving belt;

FIG. 10, shows the plan view onto a transport device in which several activators are mounted on a rotary device in the form of a disk;

FIG. 11, shows the plan view onto a transport device in which two activators are mounted on a rotary device in the form of a spoke;

FIG. 12, shows the plan view onto a transport device in which four activators are mounted on a rotary device in the form of a turnstile;

FIG. 13, shows the plan view onto a transport device in which four activators are mounted on a rotary device in the form of a rotor;

FIGS. 14A, 14B, 14C, show the cross section of the piezoelectric generator in part, in which the mechanical transducer comprises a rotatable ring with an activator mounted thereon, in different phases of the ring rotation; and

FIG. 15, shows the side view of a transport device in the form of a toothed wheel.

The following list of reference numbers can be used in conjunction with the drawings:
AA Axis of rotation
BB Axis of rotation
U Voltage at the electrical load
t Time
x First lateral direction, which coincides with the longitudinal direction of oscillation elements 8a, 8b
y Second lateral direction
z Vertical direction
1 Piezoelectric generator
2 Piezoelectric element
3 Electrical load
4 Compressive stress
5 Mechanical transducer
6, 6a, 6b, 6c Activator
7 External mechanical force
8a, 8b Oscillation elements
9a, 9b Weights
10a, 10b, 10c External electrodes of piezoelectric element 2
11 Piezoelectric layer
12 Internal electrodes
13 Stop
14 Coupling
15a 15b Connection wire
16 Ring
17 Mounting area
51 Oscillation device
61 Transport belt
62a, 62b Transport rollers
63 Projecting tongue of transport belt 61 for mounting activator 6
64 Depression in the transport rollers

### DETAILED DESCRIPTION OF ILLUSTRATIVE EMBODIMENTS

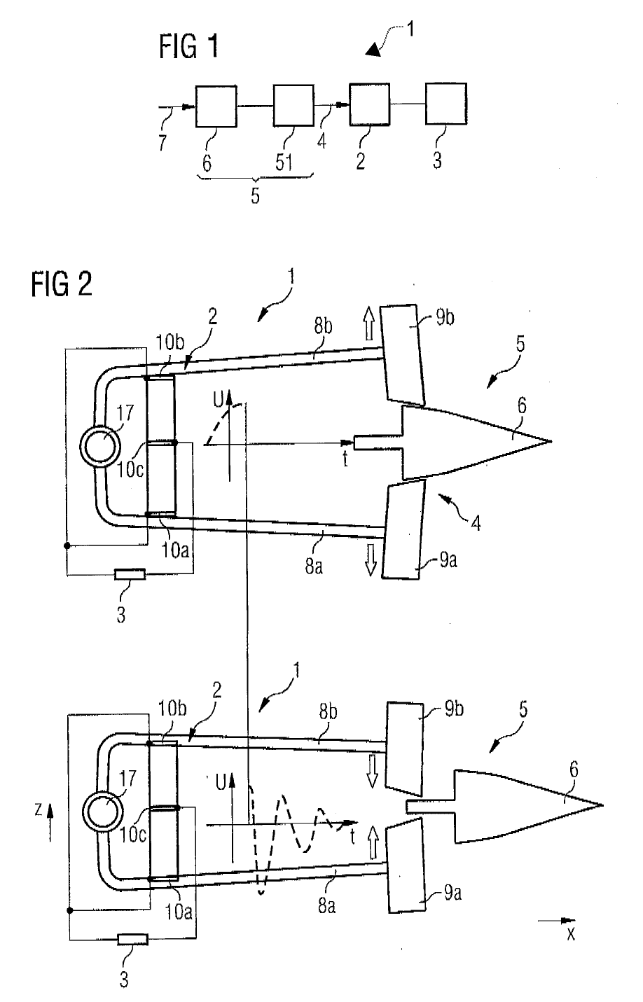

FIG. 1 shows the structure of a piezoelectric generator 1 schematically. The generator comprises a piezoelectric element 2 and a mechanical transducer 5. The mechanical transducer 5 comprises an activator 6 and an oscillation device 51. Activator 6 is a movable part that transmits the energy of an external mechanical force 7 onto oscillation device 51 and thereby causes this device to oscillate. The oscillation device 51 is in mechanical contact with piezoelectric element 2, so that the transfer of the mechanical energy to piezoelectric element 2 is possible in the oscillation of oscillation device 51.

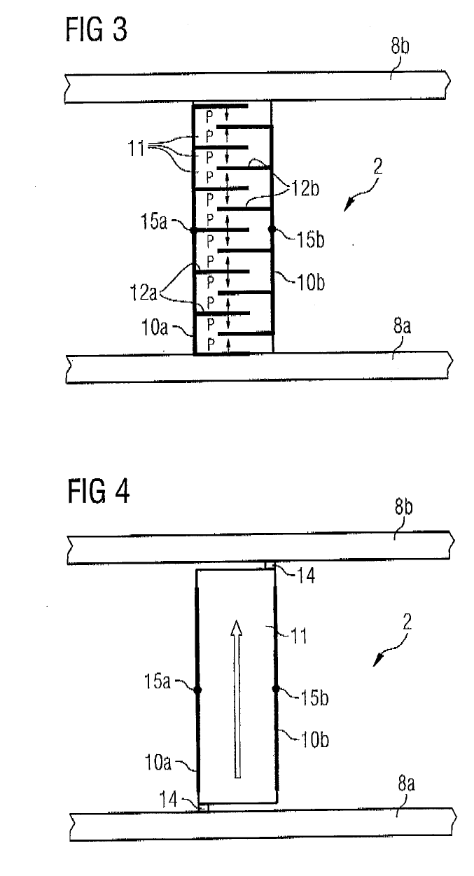

The mechanical energy is converted from one form into another in the mechanical transducer. For instance, the energy of the translational motion of activator 6 is converted into oscillations of oscillation device 51. Oscillation device 51 transmits an alternating compressive stress 4 to piezoelectric element 2 by the oscillation. Piezoelement 2 is electrically connected to an electrical load 3, a power sink. The transformation of the mechanical energy into electrical energy that is supplied to electrical load 3 takes place in piezoelectric element 2. Preferred embodiments of piezoelectric element 2 are explained in FIGS. 3 and 4. The embodiment of the piezoelectric element is not limited to these examples, however. In principle, the piezoelectric element can have any desired construction.

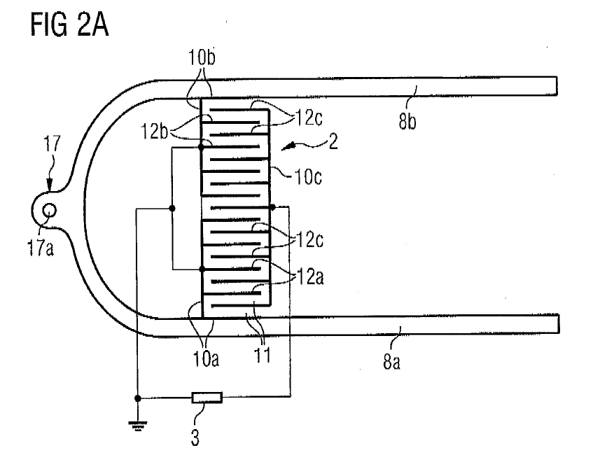

FIG. 2 shows an exemplary implementation of the piezoelectric generator with an oscillation device having the form of a tuning fork, thus being constructed as an U-piece. The U-piece has two legs and a connecting part that connects the two legs to one another. The legs of the U-piece are oscillation elements 8a, 8b, which represent the wings of the oscillation device. The oscillations of second oscillation element 8b are correlated with the oscillations of first oscillation element 8a.

The connecting part of the U-piece has a mounting area 17 in which the oscillation device is mounted on a carrier, not shown, such as the housing of the generator.

In the initial state, piezoelectric element 2 is clamped between the wings of the oscillation device in the vicinity of the connecting part, and is thereby prestressed. In one variant, piezoelectric element 2 is retained exclusively by the legs of the oscillation device. It is also possible, however, for the wings to serve primarily for periodic compressions of piezoelectric element 2, the piezoelectric element additionally being supported, held, or carried by a holding device mechanically decoupled from the oscillation device.

As one example, the wings of the oscillation device are strip-shaped cantilever springs. The oscillation device further comprises weights 9a, 9b that are respectively mounted on the free end of the oscillation element 8a, 8b, and serve to store a mechanical energy.

Oscillation elements 8a, 8b can also be mounted independently of one another on the carrier. The crucial point is that one end of oscillation element 8a and 8b can oscillate freely. Designing the oscillation device with only one oscillation element, e.g., the upper wing 8a of the oscillation device, is also conceivable if the lower wing is replaced by an immovable support.

Weights 9a, 9b in the contact area and activator 6 preferably have inclined surfaces facing one another that stop abruptly at a point that is the last to be contacted when the activator slides out of the contact area. At this point, the maximal deflection of oscillation elements 8a, 8b is achieved. The inclined surfaces preferably intersect with a horizontally oriented surface. When activator 6 has passed through the contact area of the oscillation device, an abrupt release of the oscillation elements is advantageously effected immediately after achievement of the maximum deflection of oscillation elements 8a, 8b. This makes it possible to transmit the mechanical energy most efficiently.

The activator 6 can be constructed, in particular, in the form of a wedge. The wedge shape is particularly advantageous since an abrupt release of the deflected oscillation elements is thereby enabled, after which the oscillation elements can oscillate freely.

The cross-section of the wedge widens towards the end that leaves the contact area last. The minimum spacing between weights 9a, 9b is less than the widest point of activator 6. Activator 6 moves from left to right in FIG. 2 between weights 9a, 9b and slides along the faces of these weights turned towards it. The faces of the weights contacting the activator are referred to as a contact area. As soon as the cross-sectional size of the activator exceeds the minimum spacing between weights 9a, 9b, weights 9a, 9b are pressed apart, which is indicated with arrows in the upper FIG. 2.

Weights 9a, 9b are slanted on their sides facing one another such that sliding of the wedge between these weights is facilitated. Due to the wedge shape of activator 6 and the beveling of weights 9a, 9b, it is possible to press oscillation elements 8a, 8b apart particularly efficiently and smoothly.

Weights 9a, 9b and activator 6 are preferably produced from a wear-resistant material, or at least have a layer of such a material in the areas that rub against one another.

Activator 6 can also move perpendicular to the cross-sectional plane shown in FIG. 2, the bevel of the weights preferably always running along the direction of motion of activator 6.

In the deflection of oscillation elements 8a, 8b produced by the movement of the activator, energy is stored in them. As soon as the activator leaves the contact area of the oscillation device, the weights begin to move back in the opposite direction under the effect of a restoring force. The direction of motion of oscillation elements 8a, 8b immediately after the activator slides out of the contact area is indicated by arrows at the bottom in FIG. 2. In the process, the potential energy stored in weights 9a, 9b is converted into the kinetic energy of these weights or into oscillation energy of the oscillation device, since the movement of weights 9a, 9b causes oscillation of oscillation elements 8a, 8b.

During the oscillation period of oscillation elements 8a, 8b, piezoelectric element 2 undergoes a compressive stress in the vertical direction z varying periodically with respect to time, which leads to contraction of the piezoelectric element. The compressive stress generated at piezoelectric element 2 is converted into electrical energy as follows. Due to the piezoelectric effect, an electrical charge which is supplied to the electrical load 3 appears at electrodes 10a, 10b, 10c of piezoelectric element 2. The electrodes 10a and 10b on the end faces are both connected to a first electrode of the load 3 and the center electrode 10c of the piezoelectric element is connected to a second electrode, so that the electric charge can flow out of piezoelectric element 2.

The dependence of the alternating voltage U measured at load 3, at time t is schematically illustrated in FIG. 2. This voltage is proportional to the amplitude of the mechanical oscillations of oscillation elements 8a, 8b. This amplitude diminishes over time, since the oscillations are damped by frictional losses and energy decoupling.

The tuning fork, i.e., oscillation device 51, preferably has an axis of symmetry that is oriented along the x direction. Oscillation elements 8a, 8b then oscillate against one another in opposite phase, but with the same amplitude. This mechanical synchronization of the oscillation elements can be achieved with a substantially identical construction of the oscillation elements, or with a symmetrical construction of the oscillation device, for the same deflection of the two oscillation elements in mutually opposed directions. The same deflection can be achieved by a preferably symmetrical construction of activator 6.

The area of the connecting part that lies in the vicinity of the axis of symmetry of the oscillation device remains substantially immobile during oscillation of the oscillation elements 8a, 8b. The mounting area 17 is preferably arranged in this area of the connecting part. Thus the oscillations of oscillation elements 8a, 8b are damped only slightly by the connection to the carrier.

Piezoelectric element 2 preferably has a resonance frequency that essentially coincides with the oscillation frequency of the oscillation device.

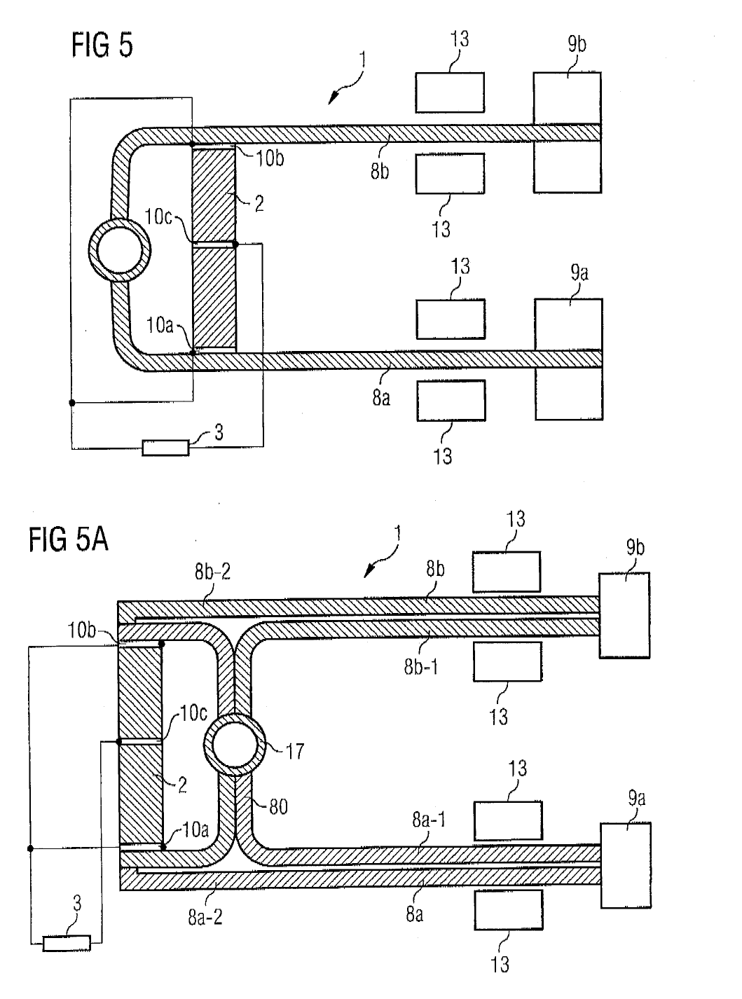

The piezoelectric element 2 shown schematically in FIGS. 2 and 5 is explained in FIG. 2A. Another embodiment of piezoelectric element 2 is shown in FIG. 3.

The piezoelectric element 2 shown in FIGS. 2A and 3 represents a multilayer component or a piezoelectric stack, i.e., a stack of piezoelectric layers 11 and metal layers alternately arranged. Each metal layer is formed into an internal electrode 12a, 12b or 12c. The internal electrodes of one type are conductively connected to one another and are electrically isolated from the internal electrodes of the other types. The first internal electrodes 12a are connected to a first external electrode 10a, the second internal electrodes 12b are connected to a second external electrode 10b and the third internal electrodes 12c are connected to a third external electrode 10c. External electrodes 10a, 10b, 10c are arranged on the surface of piezoelectric element 2.

In the lower part of piezoelectric element 2 shown in FIG. 2A, the first and the third internal electrodes 12a, 12c are arranged alternately. In the upper part of this piezoelectric element, the second and third internal electrodes 12b, 12c are arranged alternately.

External electrodes 10a and 10b are preferably both connected to ground in FIG. 2A. The electrical connection between these external electrodes can be accomplished, for example, by means of the U-piece consisting of a conductive material.

In the variant shown in FIG. 2A, the mounting area 17 is constructed as a tongue that branches off from the U-piece and extends along the axis of symmetry of the U-piece. This tongue is furnished with an opening 17a for accommodating a fastening element such as a screw.

A connection wire 15a, 15b is respectively connected to external electrodes 10a, 10b (FIG. 3), preferably being soldered on. External electrodes 10a, 10b are oriented in FIGS. 3 and 4 perpendicular to the main surfaces of oscillation elements 8a, 8b, and in the variant according to FIGS. 2, 2A they are partially oriented parallel thereto.

The polarization vector P of each piezoelectric layer 11 is preferably oriented perpendicular to the main surfaces of oscillation elements 8a, 8b. The polarization vectors P in the variant shown in FIG. 3 are oriented perpendicular to the electrode surfaces, in this variant, to the surfaces of internal electrodes 12a and 12b, and perpendicular to the main surfaces of oscillation elements 8a, 8b.

The output resistance of piezoelectric element 2 is preferably matched to the input resistance of the electrical load 3. This is advantageous for an optimal transmission of the electrical energy generated in the piezoelectric element, so that a particularly large value for the efficiency of the piezoelectric generator can be achieved. A predetermined impedance of piezoelectric element 2, as well as its output voltage, can be adjusted by a suitably selected overall thickness of the piezoelectric stack, i.e., by the number and thickness of piezoelectric layers 11.

The device shown in FIG. 4 is suitable for producing a shearing deformation of piezoelectric element 2. Coupling elements 14, which are arranged between oscillation elements 8a, 8b and piezoelectric element 2 along a diagonal of piezoelectric element 2, are provided for this purpose. In principle, the coupling elements can be arranged along any desired line that runs at an incline to the vertical direction in FIG. 4.

In the oscillation phase in which the legs of the oscillation device run towards one another, the right side of piezoelectric element 2 is pressed downwards with the aid of upper coupling element 14, and its left side is pressed upwards with the aid of lower coupling element 14. In this case, oscillation elements 8a, 8b exert a shearing force on piezoelectric element 2. In the process, a shearing deformation of the base body of the piezoelectric element arises. The polarization vector P in this case is preferably oriented along the main direction of the shearing deformation.

During the oscillation of the oscillation device in the variant according to FIG. 4, a periodically varying shearing deformation of piezoelectric element 2 is produced in order to convert the mechanical energy into electrical energy. Here the piezoelectric modulus d₃₃, in particular, plays a role for this transformation.

In the variant shown in FIG. 4, the piezoelectric element is constructed as a piezoelectric layer 11 that is arranged between external electrodes 10a and 10b. The external electrodes are preferably arranged on the main surfaces of piezoelectric element 2. The polarization vector P here is oriented parallel to the surfaces of electrodes 10a, 10b and perpendicular to the main surfaces of oscillation elements 8a, 8b.

The oscillation amplitude of oscillation elements 8a, 8b should preferably not exceed a defined threshold value at which the mechanical transducer of the generator can be damaged. FIG. 5 shows an embodiment in which a stop 13 is provided to limit the oscillation amplitude of oscillation elements 8a, 8b. Each oscillation element 8a, 8b is preferably provided with its own stop 13. The stops can protect the mechanical transducer from damage in extreme conditions, such as falling, in which the device comprising the piezoelectric generator is subjected to a strong mechanical action (impact).

The oscillation elements 8a, 8b are arranged in the oscillation direction between the parts of the stops. Thus the oscillation of the oscillation element is limited on both sides. The parts of the stop are mounted on the carrier in such a manner that they do not hinder the motion of oscillating elements 8a, 8b under normal operating conditions. The distance between the two parts of stop 13 is thus selected to be larger than the maximum permissible oscillation amplitude of oscillation elements 8a, 8b. When the external force 7 exceeds a predetermined threshold value, the oscillation elements 8a, 8b strike against the stop so that their amplitude does not reach the critical value for destroying the generator.

The characteristics of the embodiments described in FIGS. 2-5 can be transferred without restriction to the embodiments described below.

FIG. 5A shows a variant of the piezoelectric generator shown in FIG. 5 in which the connecting part 80 of the oscillation device subdivides the respective oscillation elements 8a, 8b into two oscillation arms 8a-1 and 8a-2, as well as 8b-1 and 8b-2. Oscillation arms 8a-2, 8b-2 are formed shorter than oscillation arms 8a-1, 8b-1 connected to the weights 9a, 9b. Connecting part 80 in this case is arranged between piezoelectric element 2 and weights 9a, 9b.

Oscillation arms 8a-1 and 8a-2 form a first lever device. Oscillation arms 8b-1 and 8b-2 form a second lever device. The lever devices are connected to one another in their substantially immovable areas by connecting part 80 and run synchronously but in opposite phase.

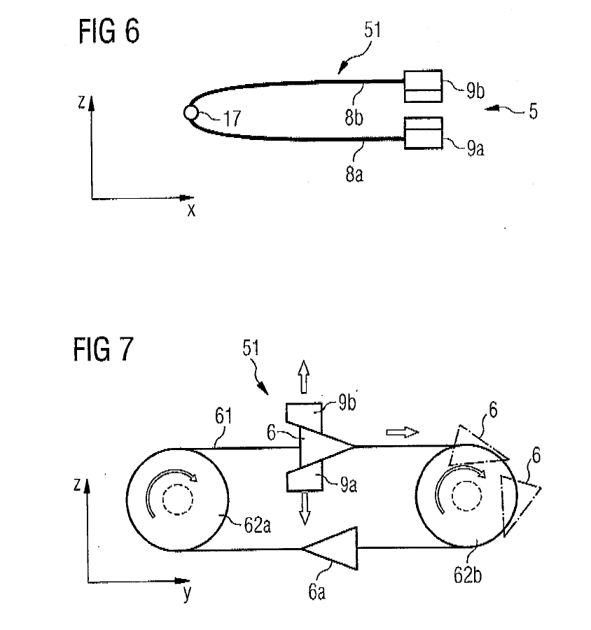

FIGS. 6-13 show sections of a mechanical transducer in which, in contrast to the oscillation device shown in FIG. 2, the activator, not shown here, does not run along the longitudinal direction x of oscillation elements 8a, 8b, but rather in a different lateral direction y, i.e., transverse thereto. Weights 9a, 9b are slanted in such a manner that the distance between them decreases in the y direction.

The oscillation frequency of oscillation device 51 can be adjusted by the mass of weights 9a, 9b, the length of oscillation elements 8a, 8b and the position of piezoelectric element 2. The oscillation frequency is preferably equal to the resonance frequency of piezoelectric element 2.

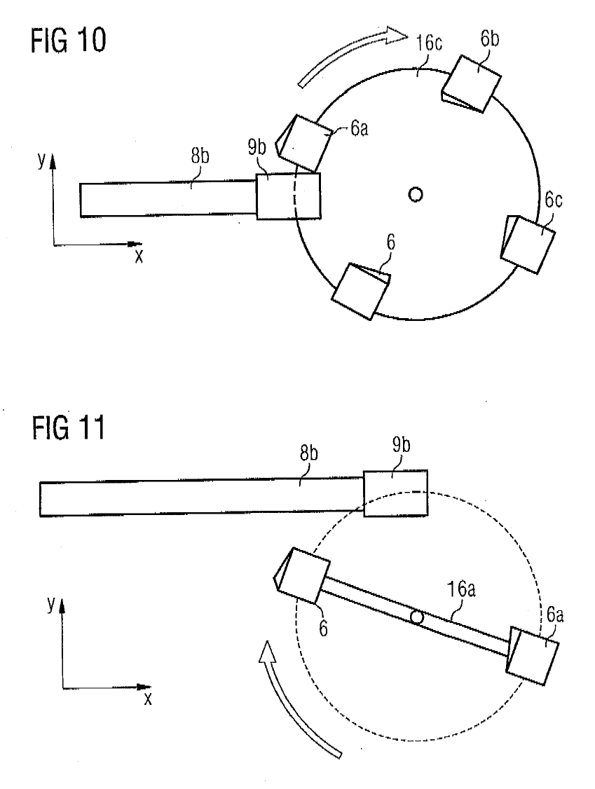

The excitation of oscillation device 51 by activator 6 can be periodic, the period of the excitation preferably being equal to, or an integer multiple of, the oscillation period of oscillation device 51. Then a resonance condition with respect to the oscillation frequency of the oscillation device is fulfilled for the excitation in the mechanical transducer. If needed, the excitation period can be reduced, and thus the excitation frequency increased, by using several preferably identical activators 6, 6a, 6b, 6c according to FIGS. 7 and 10-13, instead of only one activator 6, the successive activators being arranged at equal intervals on a transport device. The transport device can be a transport belt as in FIGS. 7-9, or a rotary device as in FIG. 10. Each activator is preferably constructed symmetrically with respect to the principal plane of the transport device.

FIG. 7 presents a transport device that displaces activator 6 linearly in the y direction, i.e., from left to right. The transport device comprises a transport belt 61 on which activator 6 is mounted. An additional activator 6a is also mounted on this belt.

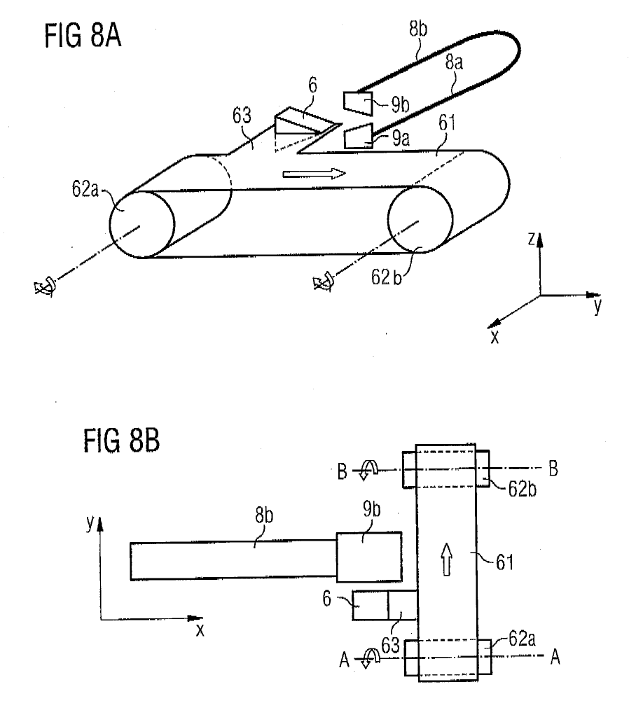

The transport rollers 62a, 62b each rotate clockwise about an axis of rotation AA and BB, respectively, (see FIG. 8B) running perpendicular to the drawing plane in FIG. 7, and they therefore cause transport belt 61 to move in the clockwise direction as well. Different movement phases of activator 6 are indicated with dashed lines.

The first realization of a transport device shown in FIG. 7 is shown in different views in FIGS. 8A and 8B. Transport belt 61 has a laterally projecting tongue 63 on which the wedge-shaped activator 6 is mounted. Tongue 63 projects in a direction that runs transverse to the motion direction of transport belt 61 or activator 6.

Whenever the activator passes through the contact area of the oscillation device, the deflection of weights 9a, 9b, already explained in connection with FIG. 2, occurs.

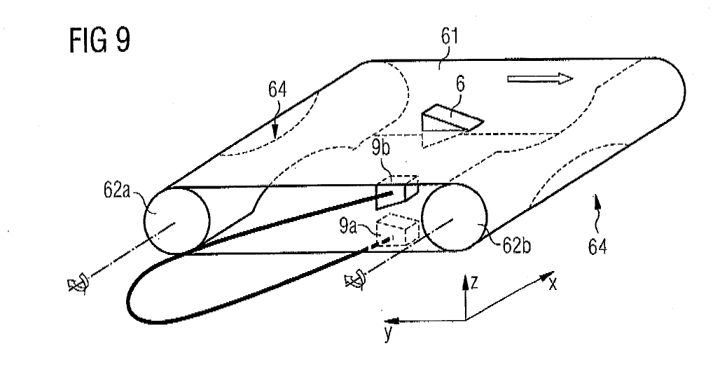

The lower part of transport belt 61 is arranged in FIG. 9 between oscillation elements 8a, 8b. Activator 6 is arranged here, in contrast to the variant according to FIGS. 8A, 8B, in the center area of transport belt 61. In order that the part of activator 6 turned inward is also able to pass through the area of the transport rollers without hindrance, the transport rollers 62a, 62b each have an area 64 with a smaller cross-section than the areas on them that are provided for transporting the belt. The travel path of activator 6 runs between weights 9a, 9b.

The activator can be mounted on a rotary device as in FIG. 10, instead of a transport belt. Several activators can be mounted on the rotary device, whereby the excitation frequency at the constant rotational frequency of the rotary device can be increased relative to the variant with only one activator. The arrangement of the rotary device and the activators is preferably point-symmetrical with respect to its center located on the axis of rotation.

In FIG. 10, the rotary device is realized as a disk 16c that rotates about an axis which is perpendicular to the principal planes of the disc.

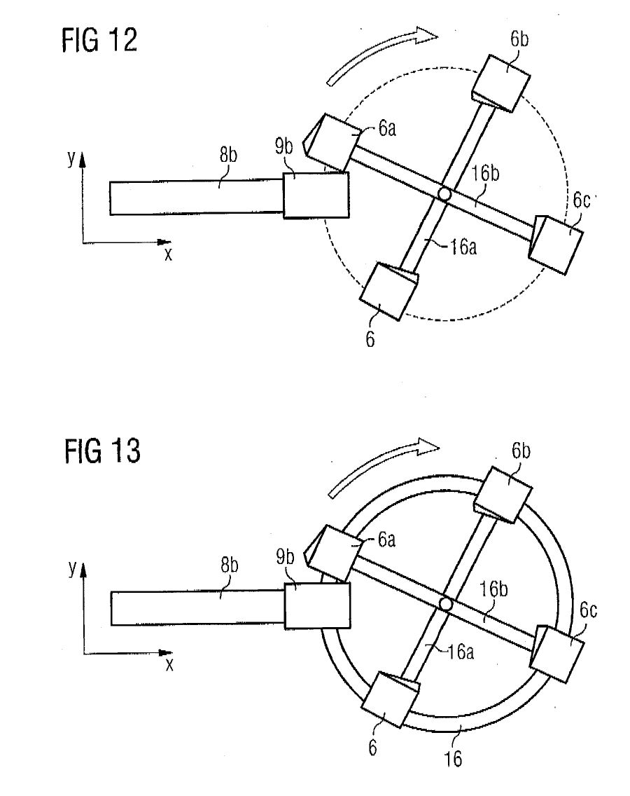

The rotary device can have at least one bar 16a, 16b (FIGS. 11, 12) that runs perpendicular to the axis of rotation and is rotatable about the axis of rotation. In FIG. 11, the rotary device is realized as a bar 16a, through the center of which the rotational axis passes, with an activator mounted at each end of bar 16a.

The rotary device can also be realized in the form of a turnstile as in FIG. 12. Therein, several bars run outward from the axis of rotation, each along a radial direction. The bars thus form a preferably symmetrical star arrangement. The ends of the bars can be connected to one another by a rim, the ring 16 in FIG. 13, with the rotary device having the form of a rotor.

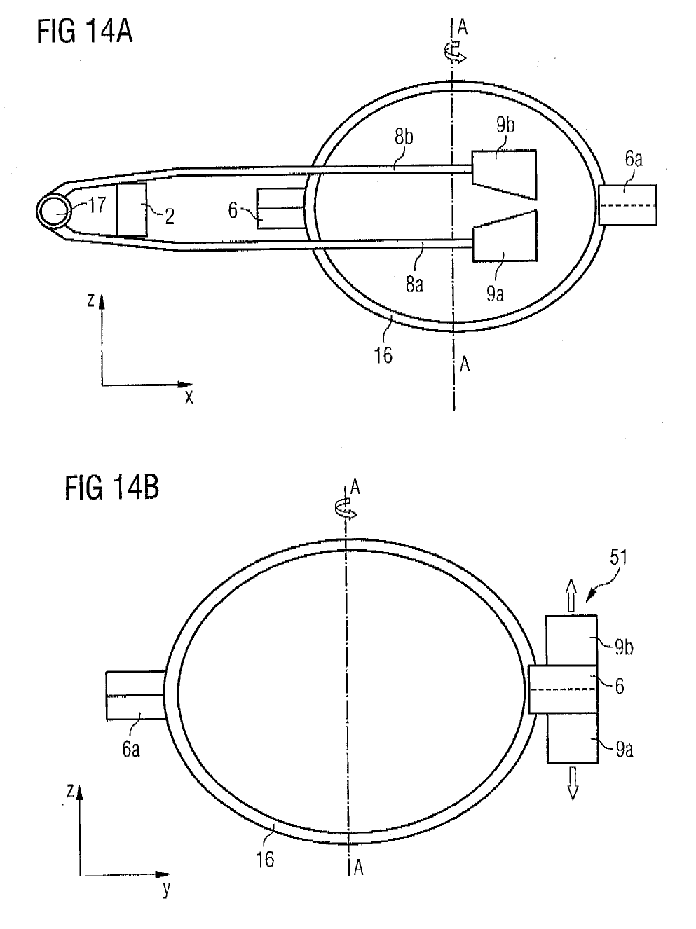

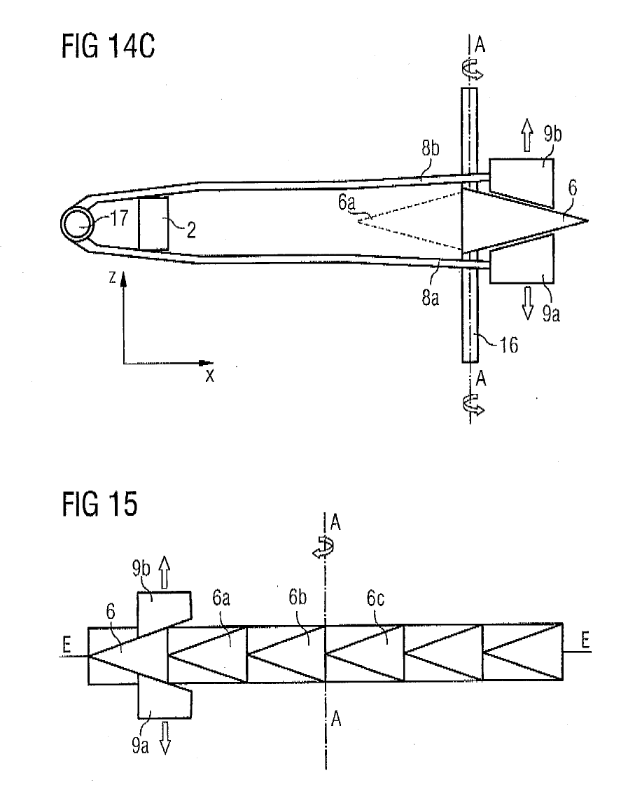

FIGS. 14A, 14B, 14C show an oscillation device that comprises, in addition to the oscillation elements 8a, 8b in the form of a cantilever spring, a ring 16 that is rotatable about an axis of rotation AA and on which the preferably wedge-shaped activator 6 is mounted. Axis of rotation AA runs transverse to the longitudinal direction of oscillation elements 8a, 8b outside the three dimensional area in which these oscillation elements and the weights 9a, 9b are arranged. Under the influence of an external force, activator 6 moves counterclockwise in a circle, along the dash lined in FIG. 14A. Axis of rotation AA and the diameter of ring 16 are preferably selected such that activator 6 can slide between weights 9a, 9b in the predetermined range of the rotational phase of ring 16.

Two substantially identical activators 6 and 6a are preferably provided on ring 16. During rotation of the ring, activator 6, 6a slides between weights 9a, 9b, whereby the above-explained movement of oscillation elements 8a, 8b away from one another is caused. This is shown at the bottom in FIG. 14C.

In any case, a section of the path of each activator 6, 6a, 6b, 6c runs between oscillation elements 8a, 8b.

A rotary device in the form of a gearwheel is shown FIG. 15. The gearwheel is preferably symmetric with respect to the plane EE that is oriented transverse to the rotational axis AA and runs through the center point of the wheel. The activators 6, 6a, 6b, 6c are arranged along the circumference of the wheel, and each represents a projection in a radial direction.

What is claimed is:

1. A piezoelectric generator comprising:
a piezoelectric element; and
an oscillation device having oscillation elements that can oscillate in opposition to one another, wherein the piezoelectric element is clamped between the oscillation elements and converts mechanical energy of the oscillation device into an electrical signal.

2. The piezoelectric generator according to claim 1, wherein the oscillation device is constructed such that the oscillation elements oscillate in opposite phase but with an amplitude of the same magnitude.

3. The piezoelectric generator according to claim 1, further comprising an activator that transmits a mechanical force to the oscillation device to excite oscillations of the oscillation device.

4. The piezoelectric generator according to claim 3, wherein the oscillation device and the piezoelectric element together form a resonant system that is excited to resonance by the activator.

5. The piezoelectric generator according to claim 3, wherein the oscillation device can oscillate with an oscillation frequency predetermined by the activator, the oscillation frequency being different from a natural frequency of the oscillation device.

6. The piezoelectric generator according to claim 1, wherein oscillation elements form legs of an U-piece that are mounted on a carrier.

7. The piezoelectric generator according to claim 1, wherein the oscillation device is mounted on a carrier whose vibrations cause the oscillation device to oscillate.

8. The piezoelectric generator according to claim 1, wherein the oscillation device is set into oscillation by air pressure.

9. The piezoelectric generator according to claim 3, wherein the activator comprises a movable part that is suited to change the distance between the oscillation elements.

10. The piezoelectric generator according to claim 3, wherein the activator is wedge-shaped.

11. The piezoelectric generator according to claim 3, further comprising a transport device, the activator being mounted on the transport device.

12. The piezoelectric generator according to claim 11, wherein the transport device is rotatable about an axis of rotation and wherein the activator causes the oscillation elements to be pushed apart in rotational phases of the transport device.

13. The piezoelectric generator according to claim 11, wherein the transport device comprises a transport belt on which the activator is mounted.

14. The piezoelectric generator according to claim 1, wherein the piezoelectric element comprises electrodes and at least one piezoelectric layer arranged between the electrodes.

15. The piezoelectric generator according to claim 14,
wherein the at least one piezoelectric layer has a preferred polarization direction that is oriented transverse to principal surfaces of the oscillation elements; and
wherein the preferred polarization direction of the at least one piezoelectric layer is oriented transverse to the electrodes of the piezoelectric element.

16. The piezoelectric generator according to claim 14,
wherein the at least one piezoelectric layer has a preferred polarization direction that is oriented transverse to principal surfaces of the oscillation elements,
wherein the electrodes of the piezoelectric element are each oriented substantially parallel to the preferred polarization direction of the at least one piezoelectric layer.

17. The piezoelectric generator according to claim 16, further comprising coupling elements that create a shearing deformation of a base body of the piezoelectric element during oscillation of the oscillation device, the coupling elements arranged between the piezoelectric element and the oscillation elements.

18. The piezoelectric generator according to claim 3, wherein the activator contacts free ends of the oscillation elements under the effect of an external mechanical force.

19. The piezoelectric generator according to claim 18, wherein the oscillation elements each have a weight in an area of their free ends that is contacted by the activator.

20. The piezoelectric generator according to claim 3, wherein either or both of the activator and/or the oscillation elements have a wear-resistant layer at least in a contact area between the activator and the oscillation elements.

21. The piezoelectric generator according to claim 19, wherein sides of the weights facing one another are slanted such that the distance between the weights decreases with a distance from a starting position of the activator.

22. The piezoelectric generator according to claim 21, wherein a minimum spacing between the weights in a rest position is less than a widest point of the activator.

23. The piezoelectric generator according to claim 21, further comprising a limiting element for each oscillation element, the limiting element to limit an oscillation amplitude of the respective oscillation element.

24. The piezoelectric generator according to claim 1, wherein each oscillation element is mounted at a common mounting point.

25. The piezoelectric generator according to claim 24, wherein the oscillation elements each have a curvature in a mounting area.
